(19) United States
(12) Patent Application Publication
(10) Pub. No.: US 2022/0040909 A1
(43) Pub. Date: Feb. 10, 2022

(54) METHODS, SYSTEMS, AND DEVICES FOR APPLYING A PROTECTIVE FILM TO A DEVICE

(71) Applicant: MLC Services LLC, Delray Beach, FL (US)

(72) Inventor: Brett WEBSTER, Delray Beach, FL (US)

(21) Appl. No.: 17/374,229

(22) Filed: Jul. 13, 2021

Related U.S. Application Data
(60) Provisional application No. 63/063,912, filed on Aug. 10, 2020.

(51) Int. Cl. B29C 63/00; B29C 63/02

(52) U.S. Cl. CPC B29C 63/0004; H04B 1/3888; B29C 2063/0008; B29C 63/02

(57) ABSTRACT

Methods and systems for applying a protect film to the surface of an electronic device are provided herein. In various aspects, methods and systems disclosed herein can assist the proper alignment of a protective film with the surface of an electronic device desired to be covered.

### RELATED APPLICATIONS

This application claims priority to U.S. provisional application No. 63/063,912 filed on Aug. 10, 2020, entitled “Methods, Systems, and Devices for Applying a Protective Film to a Device,” which is incorporated herein by reference in its entirety.

### FIELD

The present teachings relate generally to protective films, and more particularly, to methods, systems, and devices for applying a protective film to a surface of an electronic device.

### BACKGROUND

Protective films are used to cover and protect a variety of materials and devices from, for example, scratches or dents that may be imparted during transport or use of the device. Protective films may be used to protect, for example, the surface of digital electronic device components during manufacture, or may be adhered to a completed device to protect it from damage during normal day-to-day use. A variety of protective films are known, each having properties that may be advantageous for some uses and disadvantageous for other uses. One form of protective film used in the art is coated on one side with a layer of a dry pressure-sensitive adhesive that has sufficient tack to form a secure contact with the device while permitting slight repositioning of the film after adherence. Protective films are often transparent, and may permit the use of touch-sensitive features of the electronic device through the film.

Typically, when a dry protective film, particularly a protective film having an adhesive layer, is applied to a surface, air may be trapped between a device surface and the film during application, causing the appearance of bubbles. Bubbles are undesirable for aesthetic reasons but also because their presence over an optical screen may distort images on a screen viewed by a device user and/or may interfere with operation of touch-sensitive features. Some prior methods of eliminating trapped air bubbles beneath protective films utilize an aqueous solution or other solvent to temporarily reduce adherence between a film and a device, permitting trapped air to be forced out by mechanical pressure. Such known methods, for example, include spraying a protective film (or device surface) with water or another liquid, applying the wet film to the device surface to be protected (or applying the film to the wet device surface), and using pressure (e.g., with a squeegee) to smooth the film and force out any trapped air bubbles. In doing so, the water or other liquid is also forced out from between the film and the device surface, and collects at an edge of the film.

While the introduction of a liquid to the outer surface of a device may be effective to help eliminate bubbles, a significant disadvantage to using such a technique is the potential introduction of liquid into the electronic device itself, for example, through the apertures for the speaker or head set jack. In some cases, liquid entering an interior housing of a device may cause the device to fail. For this reason, device manufacturers commonly include moisture sensitive indicators within their devices to help diagnose device failure. In some cases, a device's warranty may be voided where inspection of a failed device show exposure to moisture.

Another potential drawback of many protective films is the high visibility of fingerprints, smudges, or other marks on the film, resulting, for example, from handling of a device. In particular, visibility of fingerprints or other marks on films covering electronic device bodies or display screens is aesthetically and functionally undesirable. A visible residue over a display screen, for example, may distort the transmission of light from the screen resulting in distortion of an image viewed on the screen. While matte surface treatments have been used to try to address this problem, the application of some conventional matte surfaces over an optical screen may reduce optical transmission.

Additionally, another drawback of many protective films is the difficulty in their precise installation over the portions of the surfaces intended to be covered. For example, a protective film may be misaligned during installation such that one edge of the protective film overhangs an edge of the device screen while another edge of the protective film leaves a portion of the screen exposed. In such instances, the protective film may have a shortened lifespan and/or be aesthetically unappealing (e.g., due to grime accumulating under the overhanging edge of the film), while also providing insufficient protection of the exposed portion of the screen. In fact, to prevent misalignment, many users are often forced to make multiple attempts at applying the protective film to the device surface, which itself may cause distortions in the protective film (bends), decrease the effectiveness of the adhesive, and/or increase the likelihood for fingerprints or particles to be visible when the film is finally applied.

Accordingly, there remains a need for improved devices and methods for applying a protective film to the surface of an electronic device.

### SUMMARY

Embodiments of the present teachings generally provide improved methods and systems for efficient application and proper alignment of a protective film to the surface of an electronic device. Whereas conventional methods of applying protective films may require an experienced installer in order to properly align the protective film, methods and systems in accordance with the present teachings may help align the protective film with the portion of the electronic device desired to be covered on the first attempt, thereby reducing the likelihood of multiple unsuccessful attempts and/or incorrectly-applied films, which may reduce the lifespan of the film and likelihood of undesirable aesthetic applications.

In accordance with various aspects of the present teachings, an applicator for applying a protective film to a portable electronic device is provided, the applicator comprising a first clip portion and a second clip portion, each of which has an upper and lower surface. In various aspects, the lower surface of the first clip portion can comprise at least one bore and the upper surface of the second clip portion can comprise at least one protrusion that is configured to be received within the at least one bore of the first clip portion. A first projection, extending from a first side surface of one of the first and second clip portions, can be configured to engage a port of a first portable electronic device to enable alignment of a first protective film product on a first surface portion of the first portable electronic device. In various aspects, the first protective film product can comprise a protective film having a first major surface extending between a first edge and a second edge and a second major surface opposite the first major surface, wherein the first and second major surfaces are sized and shaped to correspond to the first surface portion of the first portable electronic device. The first protective film product can also include an adhesive layer disposed on the first major surface of the protective film, the adhesive layer comprising an adhesive that provides tack sufficient to securely adhere the protective film to the first surface portion of the first portable electronic device, and a first tab removably coupled to the protective film and extending beyond the first edge of the first major surface. In accordance with various aspects of the present teachings, the first tab can have at least one aperture extending therethrough for receiving the at least one protrusion of the second clip portion when retained within the bore of the first clip portion such that the first tab is disposed between the clip portions during application of the protective film to the first surface portion of the first portable electronic device.

In accordance with various aspects of the present teachings, the applicator can prevent the film from moving relative to the applicator so as to improve alignment of the film on the desired surface portion of the first portable electronic device, for example, when the projection of the applicator is inserted into the port of the first portable electronic device. By way of example, the at least one protrusion of the applicator can be configured to engage the at least one aperture of the first tab so as to limit translational motion of the protective film relative to the first and second clips. Additionally or alternatively, the at least one protrusion of the applicator can be configured to engage the at least one aperture of the first tab so as to limit rotational movement of the protective film about an axis parallel to a central axis of the at least one protrusion. In some aspects, a cross sectional shape of the at least one protrusion can be the same as a cross sectional shape of the at least one aperture. By way of non-limiting example, the cross sectional shape can be one of a circle, an ellipse, and a polygon.

In various aspects, the second clip portion can comprise a plurality of protrusions and the first clip portion can comprise a plurality of bores, wherein the first tab of the protective film comprises a plurality of apertures. In this manner, the applicator may be configured such that each of the plurality of protrusions of the second clip portion can be configured to simultaneously extend through one of the plurality of apertures in the first tab to engage one of the plurality of bores of the first clip portion. In some aspects, for example, each of two protrusions of the applicator can engage one of two circular apertures in the tab, thereby limiting translational and rotational movement of the protective film.

The first and second clip portions of the applicator can be secured in a variety of manners. For example, in some aspects, the first and second clip portions can be configured to be coupled via press fit. In some related aspects, the at least one protrusion of the second clip portion can be configured to be retained within the at least one bore of the first clip portion via compression fit.

In accordance with various aspects of the present teachings, the applicator can be configured to allow for the installation of different film products of different configurations onto a variety of desired surfaces of portable electronic devices of various makes or models. By way of example, in some aspects, the first projection of the applicator may be configured to enable alignment of a second protective film product to a second surface portion of the first electronic device, wherein the first and second surface portions are disposed on opposite sides of the first electronic device (e.g., front and back of the same electronic device). In such aspects, the second protective film product can comprise a protective film having a first major surface extending between a first edge and a second edge and a second major surface opposite the first major surface, wherein the first and second major surfaces are sized and shaped to correspond to the second surface portion of the first portable electronic device (e.g., the back of the portable electronic device). The second protective film product can also comprise an adhesive layer disposed on the first major surface of the protective film, the adhesive layer comprising an adhesive that provides tack sufficient to securely adhere the protective film to the second surface portion of the first portable electronic device. The second protective film product may also comprise a first tab removably coupled to the protective film and extending beyond the first edge of the first major surface, the first tab having at least one aperture extending therethrough for receiving the at least one protrusion of the second clip portion when retained within the bore of the first clip portion such that the first tab is disposed between the clip portions during application of the protective film to the second surface portion of the first portable electronic device.

As noted above, the applicator can also be configured to allow for the installation of different film products onto portable electronic devices of different makes or models. For example, in some aspects, the applicator may comprise a second projection extending from a second side surface opposed to the first side surface, wherein the second projection is configured to engage a port of a second portable electronic device to enable alignment of a second protective film product to a first surface portion of the second portable electronic device, wherein the second portable electronic device is different from the first portable electronic device. In certain related aspects, the second protective film product may comprise a protective film having a first major surface extending between a first edge and a second edge and a second major surface opposite the first major surface, wherein the first and second major surfaces are sized and shaped to correspond to the first surface portion of the second portable electronic device. In some aspects, the size and shape of the first surface portions of the first and second electronic devices may be different though the same applicator can be used to apply different protective films to surfaces of both the first and second devices, which may be different.

In various aspects, the present teachings also provide protective film products comprising a protective film configured to be applied to a surface of a portable electronic device desired to be protected. For example, in certain aspects, a protective film product for a portable electronic device is provided, the protective film product comprising a protective film having a first major surface extending between a first edge and a second edge and a second major surface opposite the first major surface, wherein the first and second major surfaces are sized and shaped to correspond to a surface portion of the portable electronic device. An adhesive layer may be disposed on the first major surface of the protective film, the adhesive layer comprising an adhesive that provides tack sufficient to securely adhere the protective film to the surface portion of the portable electronic device. A first tab, removably coupled to the protective film and extending beyond the first edge of the first major surface, includes at least one aperture extending therethrough for receiving a protrusion of an applicator during application of the protective film to the surface portion of the portable electronic device. In various aspects, the first tab may be configured to engage the applicator so as to align the protective film with the surface portion of the portable electronic device during application. For example, the first tab may be configured to engage the applicator so as to limit translational motion of the protective film relative to the applicator and/or to limit rotational movement of the protective film about an axis parallel to a central axis of the protrusion.

In various aspects, the protective film product may comprise a removable cap sheet disposed on the second major surface of the protective film. Additionally, in some aspects, at least a portion of the first tab may be integrally formed with the cap sheet. In some related aspects, the first tab may comprise the cap sheet and a tab portion of the same material as the protective film. In such aspects, the tab portion may be configured to separate from the first edge of the protective film when the cap sheet is removed. By way of example, the tab portion may be integrally connected with the first edge of the protective film via a set of perforations or a kisscut.

In some aspects, however, the first tab does not include a cap sheet. Instead, the first tab may consist of the same material as the protective film, and which may be integrally formed with the protective film. For example, the first tab may be connected to the first edge of the protective film via a set of perforations or a kisscut to allow the first tab to be removed from the first major surface after adhering the protective film to the portable electronic device.

The apertures can have a variety of configurations for engagement with the applicator. By way of example, some aspects of the present teachings provide that the cross sectional shape of the at least one aperture in the first tab may be the same as a cross sectional shape of the protrusion in the applicator (e.g., a circle, an ellipse, and a polygon). In certain aspects, the first tab may include a plurality of apertures and the applicator includes a plurality of protrusions, wherein each of the plurality of apertures is configured to simultaneously receive therethrough one of the plurality of protrusions during application of the protective film product.

In various aspects, the protective film product may also comprise a second tab, which is removably coupled to the protective film and extends beyond the second edge of the first major surface. In this manner, the protective film product may have a first tab extending beyond the first edge of the first major surface and a second tab extending beyond the second edge of the first major surface.

Also disclosed herein are methods of applying one or more protective film products to a portable electronic device. In some example aspects, the method may comprise providing a protective film and applicator as otherwise discussed herein. At least one protrusion of the applicator may be inserted through an aperture of the tab of the protective film product, and the first and second clip portions may be coupled, for example, by inserting the at least one protrusion of the first clip portion into a bore of the second clip portion. The projection of the applicator may be inserted into a port of a portable electronic device to align the protective film with the surface portion of the portable electronic device desired to be covered. Pressure may then be applied to the second major surface of the protective film product to press the adhesive layer (disposed on the opposed first major surface of the protective film) against the surface portion of the portable electronic device. The tab and applicator may then be removed with the protective film adhered and aligned with the surface portion of the portable electronic device.

These and other features of the applicant's teachings are set forth herein.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1 depicts in perspective view an exemplary protective film product to be applied to a portable electronic device in accordance with various aspects of the present teachings.

FIG. 2 depicts a side view of the protective film product of FIG. 1.

FIGS. 3A-D depict an exemplary applicator for applying the protective film of FIG. 1 to a portable electronic device in accordance with various aspects of the present teachings.

FIG. 4A depicts an exemplary step of coupling the protective film product of FIG. 1 with the applicator of FIGS. 3A-D in a method of applying a protective film to a portable electronic device in accordance with various aspects of the present teachings.

FIG. 4B depicts an additional exemplary step of inserting a projection of the applicator into a port of the portable electronic device to which the protective film product is to be applied.

FIG. 4C depicts an additional exemplary step of removing a backing layer from a surface of the protective film product to expose an adhesive layer on the protective film.

FIG. 4D depicts an additional exemplary step of adhering the protective film to the portable electronic device with a mechanical smoothing device.

FIG. 4E depicts an additional exemplary step of beginning to remove a cap layer from a surface of the protective film.

FIG. 4F depicts an additional exemplary step of removing the cap layer from the upper surface of the protective film.

FIG. 4G depicts an additional exemplary step of removing the projection of the applicator from the port of the portable electronic device.

FIG. 4H depicts the applicator and a portion of the protective film product after the applicator has been removed from the portable electronic device as in FIG. 4G.

FIG. 4I depicts the protective film applied to the portable electronic device after the applicator has been removed therefrom as in FIG. 5G.

FIGS. 5A-B depict in side and top views, respectively, another exemplary protective film product to be applied to a portable electronic device in accordance with various aspects of the present teachings.

FIGS. 6A-B depict in side and top views, respectively, another exemplary protective film product to be applied to a portable electronic device in accordance with various aspects of the present teachings.

FIGS. 7A-B depict in side and top views, respectively, another exemplary protective film product to be applied to a portable electronic device in accordance with various aspects of the present teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used in the description below and in the appended claims, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.” As used herein, the term “about,” when referring to a value, means plus or minus 10% of the value.

This disclosure is not limited to the particular systems, devices and methods described, as these may vary. Also, the terminology used in this document is only for the purpose of describing particular versions or embodiments, and it is not intended to limit the scope.

Systems and methods disclosed herein are effective to reduce the likelihood of improper installation of a protective film on an electronic device, thereby preventing potentially insufficient protection and/or disagreeable aesthetics. Indeed, the disclosed applicators and protective film products for use therewith may allow even an inexperienced user to properly align and apply the protective film to the intended surface. In various aspects disclosed herein, a single applicator may be configured to be used with a variety of protective film products, thereby enabling the sequential application of protective films to various surfaces of a plurality of different devices. For example, after installing a first protective film of a particular size and shape to the surface of a particular device (e.g., the front screen of an iPhone 11 Pro) with an applicator as disclosed herein, this same applicator may be used to apply a second protective film of a different size and/or shape to a different surface of the same device (e.g., the back of an iPhone 11 Pro). In some aspects, this same applicator may also be configured to apply protective films that are sized and shaped for electronic devices of a different make or model (e.g., the front and back of a Huawei Honor Note 10). As such, certain aspects of the present teachings enable a single applicator and one or more protective film(s) to cooperatively provide for the films' reliable installation to one or more surfaces of one or more types of electronic devices using the same applicator.

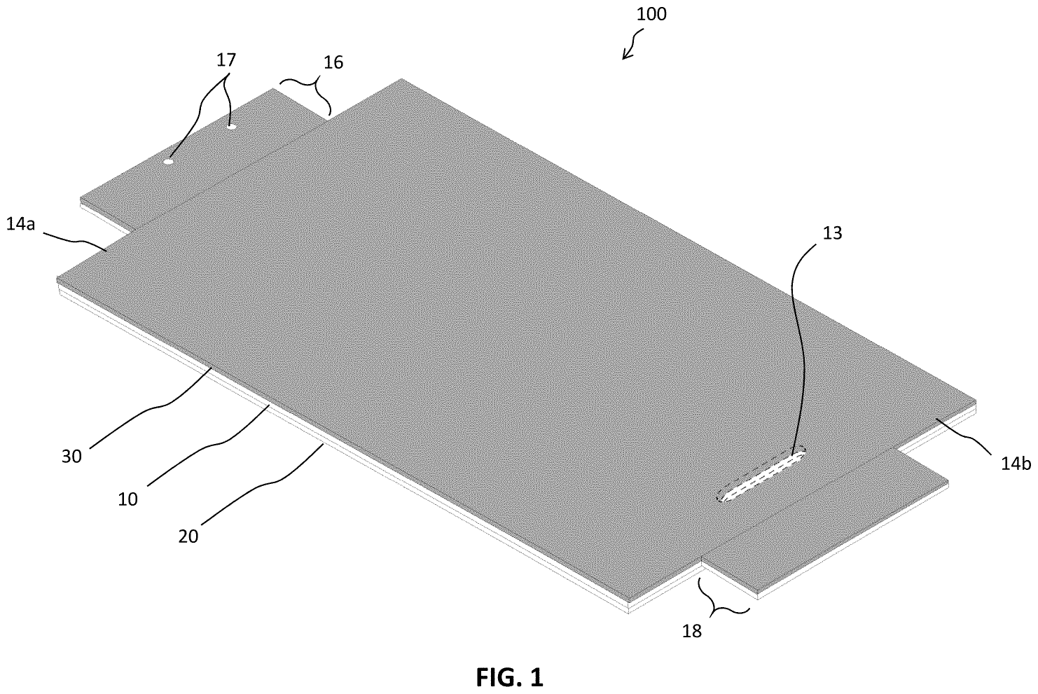

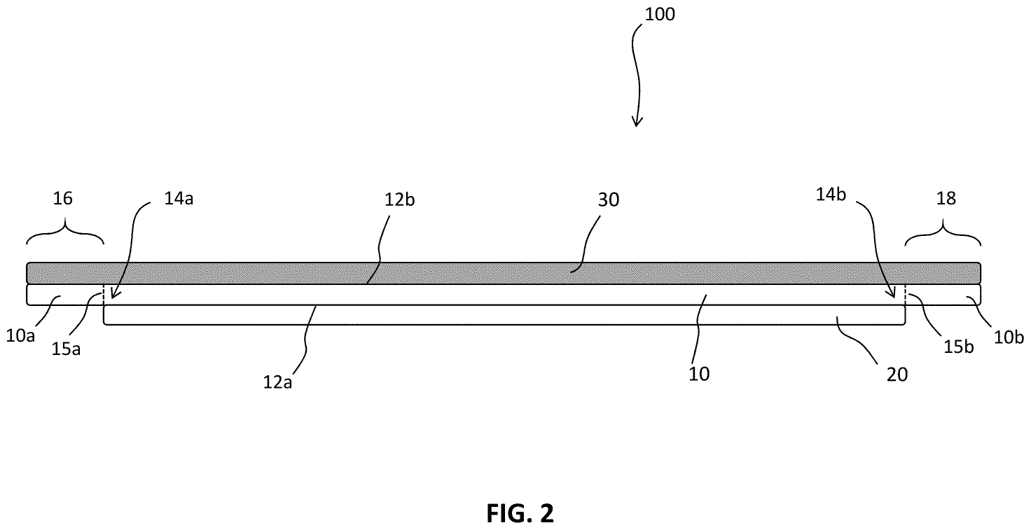

FIGS. 1 and 2 depict perspective and side views of an example multi-layer protective film product 100 according to various aspects of the present teachings. As shown, the protective film product 100 includes a protective film 10 that is generally disposed between a cap sheet 30 and a backing layer 20. The protective film 10 is configured to be installed on the surface of an electronic device (e.g., adhered to the surface), while the cap sheet 30 and backing layer 20 of the example protective film product 100 are configured to be removed during installation of the protective film 10 as discussed otherwise herein. Additionally, the example protective film product 100 includes a first tab 16 coupled to the protective film 10, but which may also be removed therefrom during installation. As discussed in detail below, the first tab 16 is configured to couple protective film 10 to an applicator that engages the electronic device during installation in order to assist with the alignment of the protective film 10 with the portion of the electronic device's surface desired to be covered. As shown in FIGS. 1 and 2, the protective film product 100 may additionally include an optional second tab 18, which acts as a handle during positioning, contacting, and/or aligning the protective film 10 with the surface of the electronic device.

With particular reference first to the middle layer of the multi-layer protective film product 100 of FIGS. 1 and 2, the example protective film 10 comprises a first major surface 12a and an opposed second major surface 12b extending between a first edge 14a and a second edge 14b. As used herein, the term “major surface” refers to a planar surface of a sheet or layer of a film, where a sheet will have two opposing major surfaces. As shown below with reference to an example installation of the protective film 10 of FIGS. 1 and 2 on a particular electronic device, protective films in accordance with the present teachings can be generally configured such that the major surfaces of the protective film correspond to the size and shape of the surface portion desired to be covered by the protective film following installation.

For example, the major surfaces 14a,b of the protective film 10 may be cut into predetermined shapes designed to fit particular portions of digital electronic devices, which may include a screen and housing. Non-limiting examples of such electronic devices include mobile telephones, personal digital assistants, eReaders, computer notebooks, netbooks, tablets, cameras, game consoles, iPods and other MP3 players, navigation devices, and GPS devices. As such, the major surfaces 14a,b of the protective film 10 may be sized and shaped to be applied to the screen and/or other portions of the digital device (such as an edge, side, corner or other portion of the housing, and/or the bezel) to protect the device from damage, using methods as otherwise discussed herein. For example, the length and width of the first and major surfaces 14a,b of the protective film can correspond to the dimensions of a screen of a particular make and model of the electronic device to prevent damage thereto (e.g., shattering of the screen). Depending on the desired protection, the present teachings also provide protective films that may provide a shock-absorbing, impact-resistant skin for other portions of the electronic device, such as the corners, edges, sides, and/or back of the device. For example, the length and width of the first and major surfaces 14a,b of the protective film 10 may include sufficient width and length to not only cover the screen, but also a side surface of the electronic device. Thus, in some related aspects, the protective film 10 may be sufficiently flexible to permit its application around corners or onto curved surfaces of the electronic device without the appearance of gaps, wrinkles, or air bubbles. Additionally, in various aspects, the protective film 10 may include one or more openings to correspond to various electronic device components so as not to block input or output ports, connections, jacks, or entry points for access to internal components of the device. As shown in FIG. 1, for example, opening 13 extends between the first and second major surfaces 14a,b at a location corresponding to the speaker of a particular electronic device when the protective film 10 is applied to the screen as discussed otherwise herein.

The protective film 10 can have a variety of thicknesses (e.g., the distance between the first and second major surfaces 14a,b). By way of example, the protective film 10 can have a thickness in the range from about 75 microns to about 400 microns (e.g., about 75 microns, about 100 microns, about 150 microns, about 175 microns, about 200 microns, about 250 microns, about 300 microns, or about 350 microns). In addition, protective films 10 of different thickness may be used depending on the portion of the device to which the protective film 10 is to be applied. For example, a protective film 10 to be applied to the optical screen of an electronic device may use a 150 micron film, while a protective film 10 configured to cover the device body (e.g., the back of the device) may comprise a 300 micron film. Such films having increased thickness may provide scratch resistance, impact resistance, or both, and may provide higher impact resistance to the parts of the device that are most likely to need it, while preserving the sensitivity and/or clarity of portions of the device that are less likely to require impact resistance.

In addition to thickness, it will be appreciated that various characteristics of the protective film 10 to be applied to different portions of the electronic device can also be varied. By way of example, a protective film 10 configured to be adhered to a device's optical screen may have a shore hardness of between about 85 A and 99 A or between about 50 D and 75 D to provide a strong film with a flat surface exhibiting minimal or no surface distortion (e.g., to avoid the “orange peel” appearance). In some particular examples, the shore hardness of the protective film 10 may be about 93 A or 60 D. As such, the protective film 10 may allow for proper optical transmission and exhibit a substantially smooth surface that mirrors the glass surface on the device. In addition to providing an aesthetic benefit, this allows for minimal or no reduction in sensitivity and/or connectivity for touch screens.

Protective films 10 may also comprise a variety of surface types, including anti-glare, glossy, or matte, and may be optically transparent, transparent with a matte texture, translucent or opaque, depending for example on the portion of the electronic device intended to be covered. By way of non-limiting examples, the protective film 10 may comprise UV absorbers, may be colored or uncolored, and/or may include a surface having a micro-matte structure. As such, a protective film 10 configured to cover different portions of a device and/or multiple protective films 10 configured to cover different portions of the same device may include various surface treatments, which may vary over a single device. For example, a protective film 10 intended to cover an optical screen may exhibit an anti-glare surface, while a protective film configured to cover that same device's body (e.g., rear surface, sides) may exhibit a matte surface. By way of further example, a protective film 10 to be adhered to the body of the device (surfaces other than the optical screen), the optical screen, or both may have a matte and/or a micro-matte finish (or additional layer), which may help to eliminate or reduce fingerprints and may add additional “grip” to the device.

As is known in the art, protective films and their associated adhesive layers for adhering the film 10 to the surface of the electronic device can comprise a variety of materials. For example, the protective film 10 may comprise a polyurethane sheet (e.g., an aliphatic polyester urethane-based sheet), with the first major surface 12a of a polyurethane sheet being coated with one or more layers of a pressure-sensitive adhesive. In some example embodiments, the protective film 10 may comprise a polycaprolactone-based aliphatic thermoplastic urethane sheet.

Various adhesives, known in the art or hereafter developed, may be used to coat all or a portion of the first major surface 12a. The thickness of the adhesive area or layer on the first major surface 12a can also vary, and in some embodiments, may be in a range from about 10 to about 100 microns (e.g., about 12-75 microns, about 25-38 microns, about 30 microns, about 35 microns). In some example embodiments, the adhesive layer may be a pressure-sensitive adhesive layer such as a polyacrylate-based adhesive copolymer. For example, the pressure-sensitive adhesive layer may comprise an acrylate-silicone copolymer, in which one or more acrylate ester groups have been modified with silicone macromer side chains. In various aspects, the adhesive layer may be prepared from or comprise acrylic acid, methacrylic acid, esters of acrylic acid comprising 4 to 21 carbon atoms, esters of methacrylic acid comprising 5 to 21 carbon atoms, acrylamide, substituted acrylamides such as N,N-dimethyl acrylamide, styrene, substituted styrenes such as vinyl toluene, acrylonitrile, methacrylonitrile, N-vinyl pyrrolidone, N-vinyl caprolactam, vinylidene chloride, vinyl esters of carboxylic acids, 2-(2-ethoxyethoxy)ethyl acrylate, 2-ethylhexyl acrylate, butyl acrylate, hydroxyethyl acrylate, hydroxypropyl acrylate, 2-carboxyethyl acrylate, ethoxyethyl acrylate, perfluorooctyl acrylate, isooctyl acrylate, divinylbenzene, vinylbenzyl chloride, vinyl acetate, glycidyl methacylate, hydroethyl acetate, hydroxypropyl acetate, glacial acrylic acid, methyl acrylate, ethyl acrylate, butyl acrylate, iso butyl acrylate or other acrylates, or combinations thereof. In some embodiments, the pressure-sensitive adhesive comprises acrylate and silicone in other polymer configurations as known in the art.

Other additional components may also be included in the adhesive layer, such as a tackifier or plasticizer, and it may be a self-healing adhesive. In various aspects, the adhesive layer may be formed without the use of a cross-linker or photo-initiator and/or the adhesive layer may be prepared using a thermal cure process. In various aspects, the adhesive layer on the protective film 10 may be made of an adhesive that does not immediately firmly secure the film to a device and thus allows for slight repositionability of the film after placement on the device. For example, the adhesive layer may include an amount of silicone to permit repositionability. In some embodiments, unpolymerized silicone, tackifier, or other low molecular weight components may be included in the adhesive layer and migrate into the polyurethane sheet so as to modify its characteristics. For example, a polyurethane sheet may be made more flexible and/or more impact resistant through the interaction with one or more such components within the adhesive layer. In some example embodiments, the protective film 10 may be a polycaprolactone-based aliphatic thermoplastic urethane and comprises an adhesive layer consisting essentially of a copolymer of an acrylate polymer and silicone macromer side chains.

Examples of protective films having suitable thickness, optical, and hardness characteristics and which may be modified in accordance with the present teachings include those manufactured by Argotec Inc. of Greenfield, Massachusetts, or other similar manufacturing companies. Examples of suitable pressure-sensitive adhesives known in the art and which may be modified in accordance with the present teachings may be manufactured by 3M Company of St. Paul, Minn. or other manufacturing companies.

In various aspects, one or more surface treatments or processes may be applied to the protective film 10 so as to alter characteristics of the protective film 10. By way of example, a micro-matte surface structure may be formed on all or a portion of the second major surface 12b of the protective film 10. As used herein, a “micro-matte surface” refers to a surface exhibiting a matte finish with an average roughness, Ra, in a range between about 0.08 nm and about 0.22 nm, or about 0.17 nm, or about 0.135 nm. For example, in some embodiments, a micro-matte surface structure may exhibit an average maximum height, Rz, between about 0.50 nm and about 1.20 nm (e.g., about 1.11 nm, about 1.23 nm). In some aspects, a micro-matte surface structure may have an average depth, Rmax, between about 1.30 nm and about 1.50 nm (e.g., about 1.40

In accordance with the present teachings, a protective film 10 having a micro-matte surface structure may be prepared by extrusion of a urethane resin onto a micro-matte textured casting sheet (e.g., a PET multi-layer film). The urethane resin forms a film that, when removed from the casting sheet, retains a micro-matte surface texture on one side (e.g., the second major surface 12b of the protective film 10) that mirrors the texture of the casting sheet. Thus, a film may be prepared by a single casting of urethane, rather than by addition of a micro-matte layer to a smooth urethane film. Alternatively, a protective film 10 having a micro-matte surface structure may be prepared as a co-extrusion of at least two layers. Accordingly, a micro-matte protective film may be prepared using multiple resins of varying hardness such that its micro-matte structure may be harder and/or more durable as may be required for specific applications. The micro-matte protective film may also comprise a pressure-sensitive adhesive layer or layers, which may be the same or similar to the pressure-sensitive adhesive layer or layers described above. In some embodiments, the micro-matte textured casting sheet may be the same or different than the cap sheet 30 described herein.

As shown in FIGS. 1 and 2, the example protective film product 100 additionally includes a backing layer 20, which can be removed from the protective film 10 to expose the adhesive area covering all or a portion of the first major surface 12a (e.g., a pressure-sensitive adhesive layer). Through the application of this adhesive area to the surface of the electronic device, the first major surface 12a of the protective film 10 can be adhered to the surface of the electronic device during installation, as discussed above. As best shown in FIG. 2, the backing layer 20 generally extends between the first and second edges 14a,b of the first major surface portion 12a. However, it will be appreciated by those skilled in the art in light of the present teachings, that one or both of the first tab 16 and second tab 18 may also include a layer of the same material as the backing layer 20 covering the first major surface 12a. As discussed otherwise herein, such a backing layer material may be removed from the tab(s) during installation (e.g., while removing backing layer 20 covering the first major surface 12a), though preferably the tab portion of the backing material is separated from the backing layer 20 (e.g., cut entirely through or partially cut (e.g., via perforations or a kisscut) such that the backing material (if present) remains on the tabs 16, 18 after removal of the backing layer 20.

As discussed otherwise herein, a protective film 10 comprising an adhesive layer (e.g., a pressure-sensitive adhesive layer) may be adhered to a device surface without the use of an aqueous solution to remove trapped air bubbles. For example, trapped air bubbles may instead be removed by applying pressure across the film surface to mechanically eliminate large (e.g., greater than 2-3 mm in diameter) air bubbles, while permitting smaller air bubbles to be eliminated over time. While the adhesive area may be protected by a removable backing 20 before being exposed to adhere the protective film 10 to the electronic device (i.e., there is no need to apply any liquid or other additive to any portion of the adhesive area or surface of the device at any time during the process), a person skilled in the art will also appreciate that the disclosed methods and systems for assisting the alignment of the protective film 10 can also be applied to protective films without a backing layer or an adhesive layer. In such aspects, water or another aqueous solution may be sprayed on the protective film (or on the device surface itself) to cause the protective film to adhere to the device and/or to remove air bubbles.

With reference still to FIGS. 1 and 2, the example protective film product 100 also includes a cap sheet 30 that is disposed adjacent the second major surface 12b of the protective film 10, and may in some aspects represent the casting film and/or sheet used during the formation of the protective film 10. In various aspects, the cap sheet may be formed out of one or more material so as to be sufficiently rigid that the pressure applied while adhering the protective film to a surface of the electronic device (e.g., by a mechanical smoothing device such as a squeegee) does not cause the cap sheet 30 or the protective film 10 to deform, which may lead to the “orange peel” appearance. Further, use of the cap sheet 30 may allow for the application of increased pressure relative to the protective film 10 alone, which may result in the reduced occurrence of air bubbles between the protective film 10 and the surface of the electronic device. Additionally or alternatively, the cap sheet 30 may also be effective to protect the second major surface 12b of the protective film 10 during manufacture, transport, and/or the end-user installation processes. In various aspects, the cap sheet 30 may thus provide an advantage over secondary application/release tapes having a cured liquid (e.g., a polyurethane and/or an acrylic material) for top coating the protective film, as the adhesive of the secondary application/release tapes may roughen or distort the adhesive layer on the first major surface 12a, which may potentially reduce the optical clarity of the protective film 10.

It will be appreciated that the cap sheet 30 can be formed out of a variety of materials, including polyester, polypropylene, nylon, polyimide, and similar high-temperature resistant materials, especially where the cap sheet 30 represents the casting film during the formation of the protective film 10. It will be appreciated, for example, that such materials may be able to resist the temperature during extrusion of the protective film 10 (e.g., about 320-350° F.) and/or exhibit a melt point greater than the temperature of the protective film extrusion. The cap sheet 30 may also exhibit a variety of thicknesses, though in certain aspects, the cap sheet 30 may be from about 0.92 mils (i.e., about 24 microns) to about 10 mils thick (i.e., about 254 microns). In certain aspects, a polyester cap sheet (e.g., a laminating roll) having a thickness of about 2 mils may provide sufficient rigidity and flexibility to prevent the cap sheet 20 and/or the protective film 10 from deforming during installation. Additionally, in certain aspects where the cap sheet 20 represents the casting film during the formation of the protective film, polyester may be preferred as it can withstand the typical extrusion temperatures of the protective film 10.

In some embodiments, at least a portion of a surface of the cap sheet 30 can exhibit a texture (e.g., brushed, ribs, ridges, grooves, raised dots, etc.), which may cause micro air pockets to form between the textured surface of the cap sheet 30 and the second major surface 12b of the protective film 10. Such air pockets may allow the cap sheet 30 to be more easily removed (e.g., by reducing a seal caused by two substantially smooth surfaces). Alternatively, the second major surface 12b of the protective film 10 may be textured so as to provide air pockets, although such texture on the protective film 10 may decrease the optical clarity of the protective film 10 and, therefore, be less desirable to the end user. Further, as discussed above with respect to aspects in which the cap sheet 30 is utilized during the formation of the protective film, the surface of the cap sheet 30 to be disposed in contact with the second major surface 12b can have a plurality of surface structures formed thereon, for example, to define a micro-matte surface to be imprinted on the second major surface 12b during casting.

Suitable materials for the cap sheet and protective film may include one or more of the following materials (or similar materials) manufactured by Argotec, Inc. of Greenfield, Mass. (or other polyurethane manufacturing companies): ARGOTHANE® aromatic polyethers/thermoplastic polyurethane (part numbers 17103, 17200, 18103, 18212, 18214, 18215, 18233, 18235, 18242, 18247, 18248, 18305, 18411, 18422, 18433, 18450-FR, 18452-FR), ARGOTHANE® aromatic polyesters/thermoplastic polyurethane (part Nos. 19102, 19103, 19205, 19422, 19424, 19426, D7101, 27303, 27370, 28304, 29100, 29102, 29213, 29222, 29285, and/or 29300), ARGOTHANE® aliphatic polyesters (part Nos. 3751 and/or AGKR), ARGOTHANE®. aliphatic polycaprolactones/thermoplastic polyurethane (part No. 46510) ARGOTHANE® waterproof breathable films/thermoplastic polyurethane (part Nos. TX1540 and/or TX2060), ARGOFLEX® waterproof-breathable films/thermoplastic polyurethane (part Nos. TX 1300, TX 1500, and/or TX2000), and/or ARGOTEC® film No. 49522.

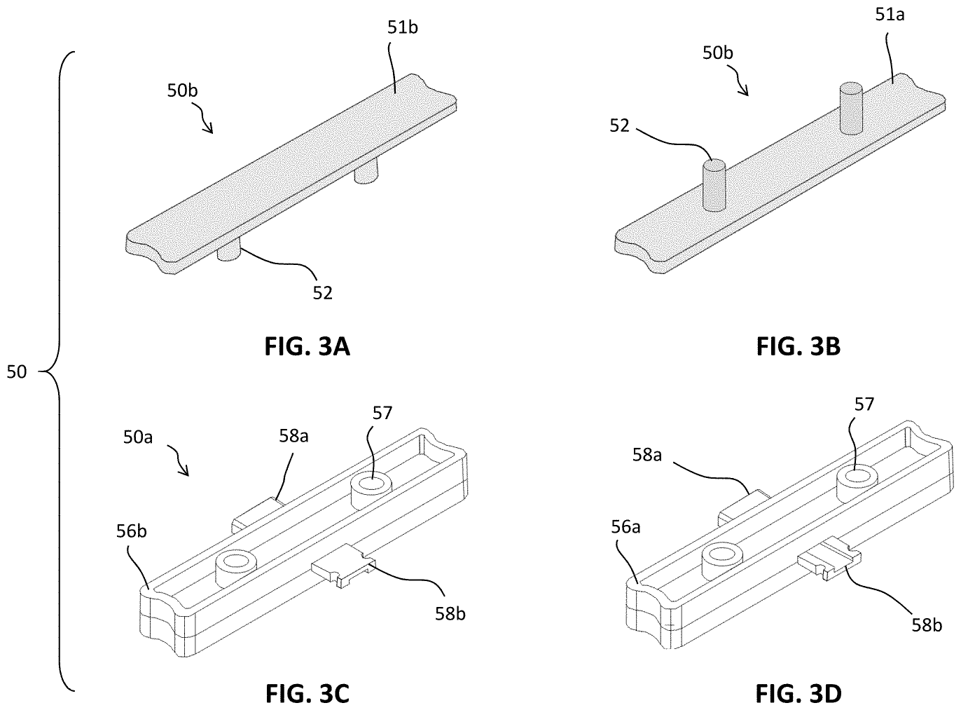

As noted above, the protective film product 100 of FIGS. 1 and 2 additionally includes a first tab 16 that extends beyond the first edge 14a of the first major surface 12a of the protective film 10 that is configured to temporarily couple the protective film 10 to an applicator (e.g., applicator 50 as discussed below with reference to FIGS. 3A-D) that engages the electronic device during installation of the protective film 10 on a surface of the device. It will be appreciated that the first tab 16 and/or applicator can include a variety of coupling features that allow the applicator to engage the first tab 16 to temporarily couple the protective film 10 to the applicator. For example, as best shown in FIG. 1, the first tab 16 includes one or more coupling features (e.g., apertures 17) that allow the protective film 10 to be coupled to an applicator during installation. In particular, the apertures 17 are configured to receive therethrough counterpart features of the applicator 50 of FIGS. 3A-D so as to limit movement of the protective film 10 relative to the applicator 50, and thus, relative to the electronic device as otherwise discussed herein. For example, the apertures 17 may be sized and spaced to receive therethrough various portions of the applicator 50 of FIGS. 3A-D. However, it should be appreciated in light of the present teachings that the first tab 16 need not include such apertures 17, but may otherwise be coupled to an applicator during installation of the protective film 10. By way of example, an applicator configured to clamp the first tab 16 (e.g., even in the absence of apertures) so as to limit movement of the protective film 10 during installation is also within the scope of the present teachings. In any event, it should be appreciated that the present teachings generally provide that the first tab 16 of the protective film product 100 is configured to couple to an applicator such that the protective film 10 may be reproducible and reliably placed during installation.

In accordance with various aspects of the present teachings, the first tab 16 may be coupled (directly or indirectly) to the protective film 10. For example, with specific reference now to FIG. 2, the first tab 16 comprises a portion of the cap sheet 30 and a tab portion 10a of the same material as that of the protective film 10. As shown, the tab portion 10a is integrally formed with and directly connected to the protective film 10 in FIG. 2, with one or more perforations or a kisscut being disposed at the first edge 14a between the tab portion 10b and the protective film 10 to allow the tab portion 10a to be separated therefrom during installation. However, because the first tab's cap sheet 30 may also be effective to couple the protective film 10 to the applicator, the first edge 14a of the protective film may represent a complete through-cut of the protective film material at the first edge 14a (i.e., the portion 10a of the tab 16 is not directly coupled to the protective film 10). Indeed, it will be appreciated that the tab portion 10a need not even be present to couple the protective film 10 to the applicator. If present, however, and whether directly or indirectly coupled to the protective film 10, the tab portion 10b can also be removed during installation, for example, due to its adherence to the cap sheet 30, which is peeled from the protective film 10 after the protective film 10 has been adhered to the device surface as discussed below.

As shown in FIGS. 1 and 2, the protective film product 100 may optionally include a second tab 18 extending beyond the second edge 14b of the protective film 10. As discussed below, this second tab 18 may act as a handle during positioning, contacting, and/or aligning the protective film 10 with the surface of the electronic device. Like the first tab 16, the second tab 18 may be coupled (directly or indirectly) to the protective film 10. For example, as best shown in FIG. 2, the second tab 18 comprises a portion of the cap sheet 30 and a tab portion 10b of the same material as that of the protective film 10, with the tab portion 10b being delineated from the protective film via perforations 15b, a kisscut, or a complete through-cut. Indeed, in some aspects, the tab portion 10b need not even be present. If present, however, and whether directly or indirectly coupled to the protective film 10, the tab portion 10b can also be removed during installation, for example, due to its adherence to the cap sheet 30, which is peeled from the protective film 10 during installation.

As noted above, the present teachings additionally provide an applicator that is configured to temporarily couple to a protective film during installation thereof (e.g., via the first tab 16 of protective film 10). In addition to coupling to the protective film, applicators in accordance with the present teachings are also configured to reliably engage the electronic device so as to enable the reproducible alignment of the protective film with the surface of the electronic device to be covered by the protective film. An example applicator 50 according to various aspects of the present teachings is depicted in FIGS. 3A-D. As shown, the depicted applicator 50 generally comprises a first clip portion 50a and a second clip portion 50b that are configured to couple to one another so as to capture the first tab 16 of the protective film product 100 of FIGS. 1 and 2. The first and second clip portions 50a,b can be coupled to one another in a variety of manners such as via snap-fit, compression-fit, clamping, etc., all by way of non-limiting example, in order to capture the first tab 16 therebetween. In addition, it will be appreciated that though the first and second clip portions 50a,b are depicted as being separate elements, the first and second portions 50a,b can also be coupled to one another (e.g., integrally connected) for example, via a flexible hinge such that the two clip portions 50a,b can pivot relative to one another so as to secure the first tab 16 therebetween.

With particular reference now to the alternate views of FIGS. 3A and 3B, the second clip portion 50b generally comprises a substantially planar body 51 having opposed upper and lower surfaces 51a,b. As shown in FIG. 3B, a plurality of protrusions 52 having a circular cross-sectional-shape extend upwardly from the upper surface 51a of the second clip portion 50b. On the other hand, the first clip portion 50a of FIGS. 3C and 3D comprises an elongate body 56 having opposed upper and lower surfaces 56a,b, with two bores 57 extending therebetween that are configured to couple with the corresponding coupling features on the second clip portion 50b. In the depicted example, the bores 57 exhibit the same circular cross-sectional shape as the protrusions 52 such that each of the bores 57 of the first clip portion 50a may be configured to simultaneously receive therein one of the protrusions 52 of the second clip portion 50b. Due to the relative sizes of at least a portion of the protrusions 52 and bores 57, the protrusions 52 may be retained within the bores 57 via an interference fit. For example, the circular protrusions 52 may exhibit a substantially constant cross-sectional area along their length, which can slightly exceed the internal dimension of the bores 57, such that the first and second clip portions 50a,b are held together by friction between the outer surface of the protrusions 52 and the inner surface of the bores 57. Alternatively, the circular protrusions 52 may exhibit a decreasing width along their length (i.e., as distance from the upper surface 51a increases) such that the first and second clip portions 50a,b may be squeezed toward one another until the protrusions 52 are sufficiently compressed to be retained within the bores 57. In various aspects, the compression fit may be reversible, for example, by pulling the first and second clip portions 50a,b away from one another. As will be discussed below, the protrusions 52 of the second clip portion 50b are also sized, shaped, and spaced to extend through the apertures 17 of the first tab 16 such that first tab 16 is retained between the first and second clip portions 50a,b when engaged with one another.

With particular reference now to FIGS. 3C and 3D, the first clip portion 50a additionally includes a first projection 58a extending from a first side of the elongate body 56 and a second projection 58b extending from an opposed side of the elongate body 56. As discussed below, each of these projections 58a,b can be configured to be securely retained with an entry point of at least one type of electronic device (e.g., a port or jack), thereby securing the applicator 50 and first tab 16 of the protective film product 100 in a predetermined, fixed location relative to the electronic device to which the protective film 10 is being applied. By way of non-limiting example, one of the first and second projections 58a,b of the first clip portion 50a can be shaped and sized like one of a USB connector, a microUSB connector, a headphone jack, a lightning connector (e.g., for an Apple iPhone or iPad), a pin connector, or any other connector presently known in the art or hereafter developed, while the other projection 58a,b is sized and shaped like a different connector. In this manner, an applicator 50 can be configured to securely engage the entry point of more than one type of device, thereby enabling a single applicator to apply a protective film to a plurality of devices in accordance with various aspects of the present teachings as otherwise discussed herein.

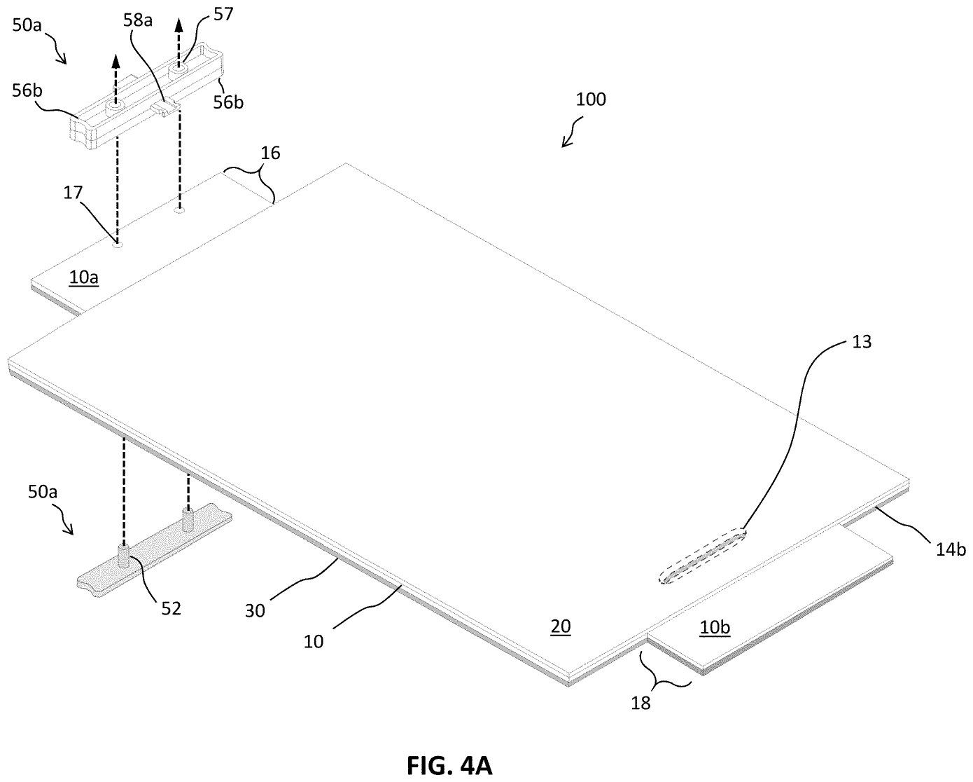

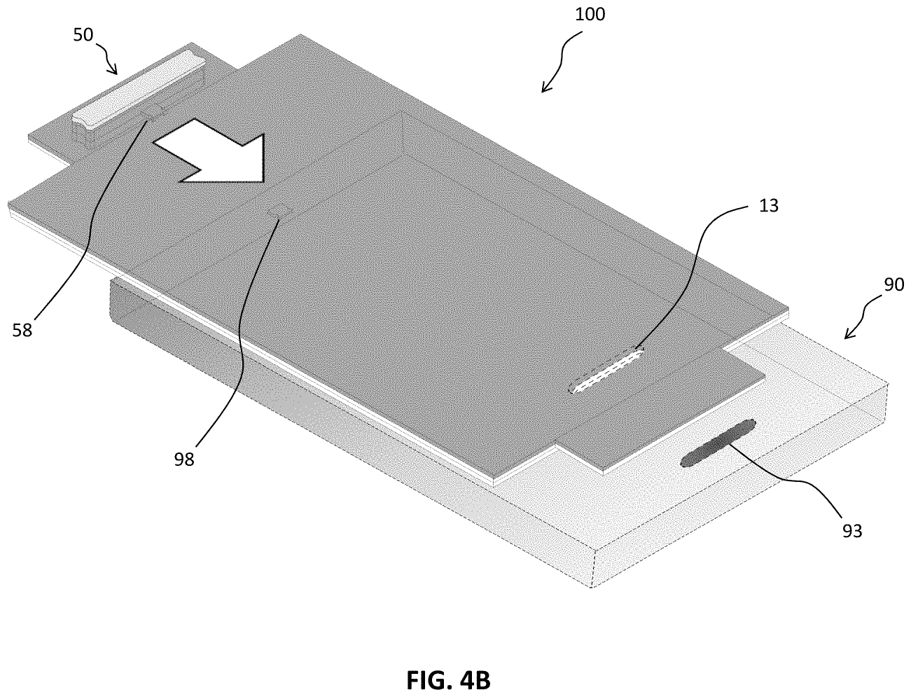

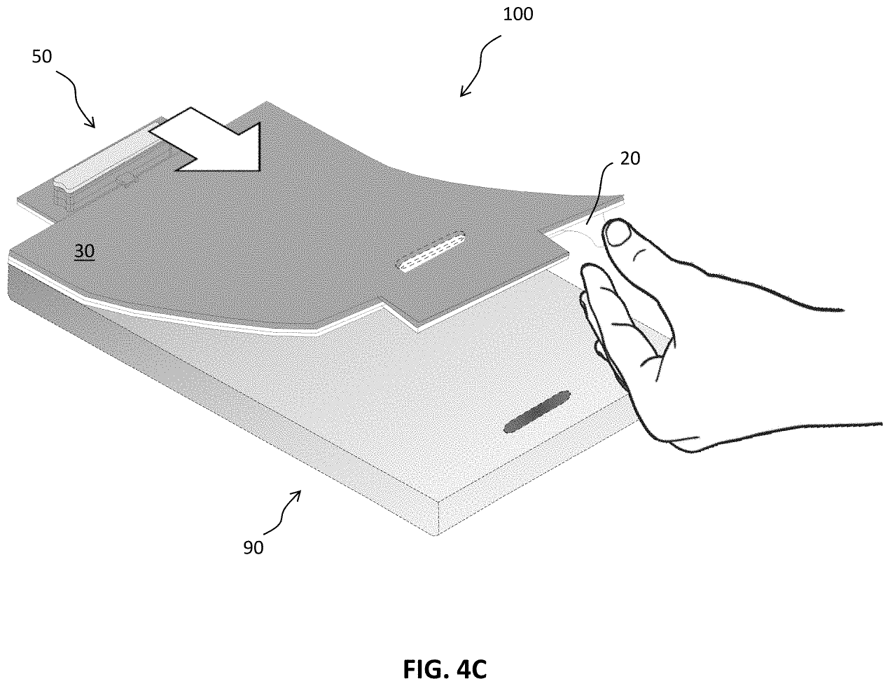

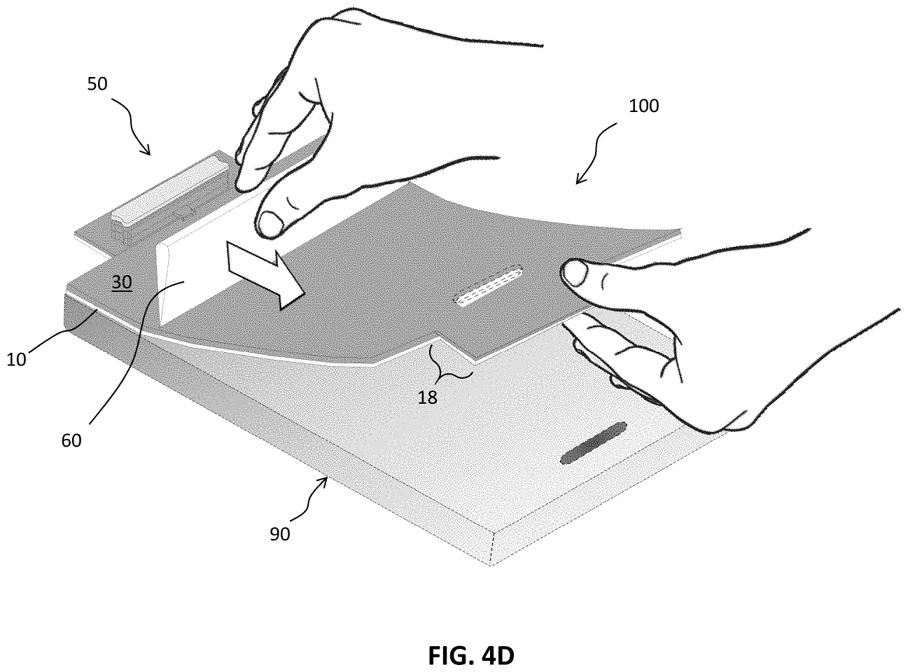

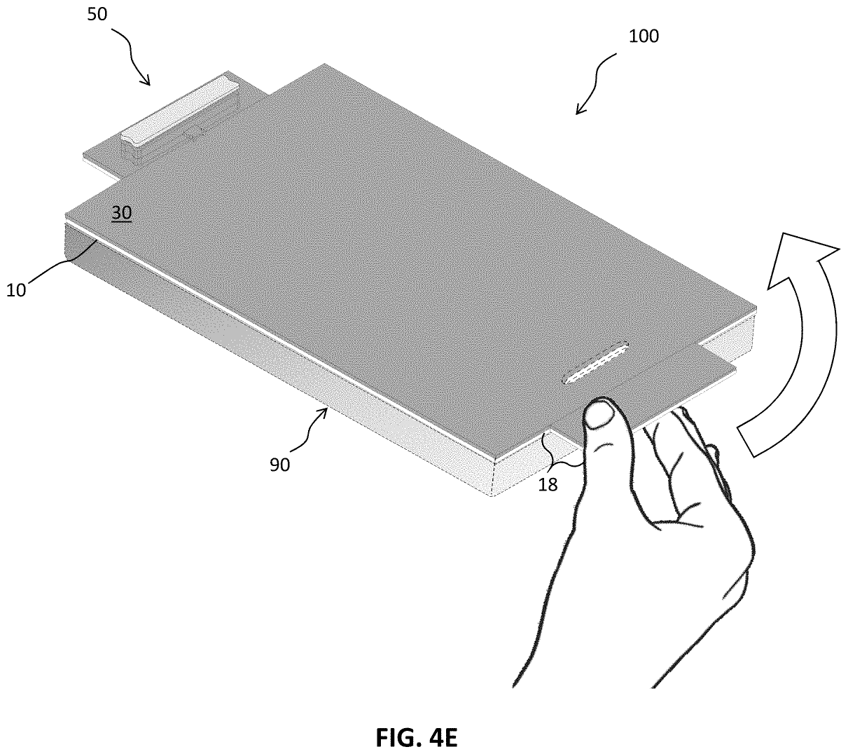

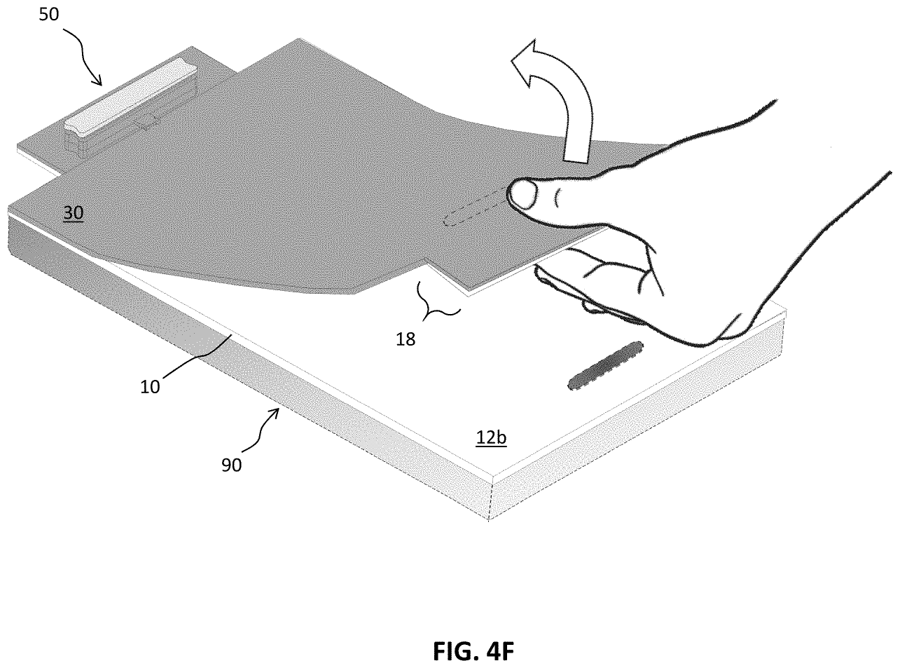

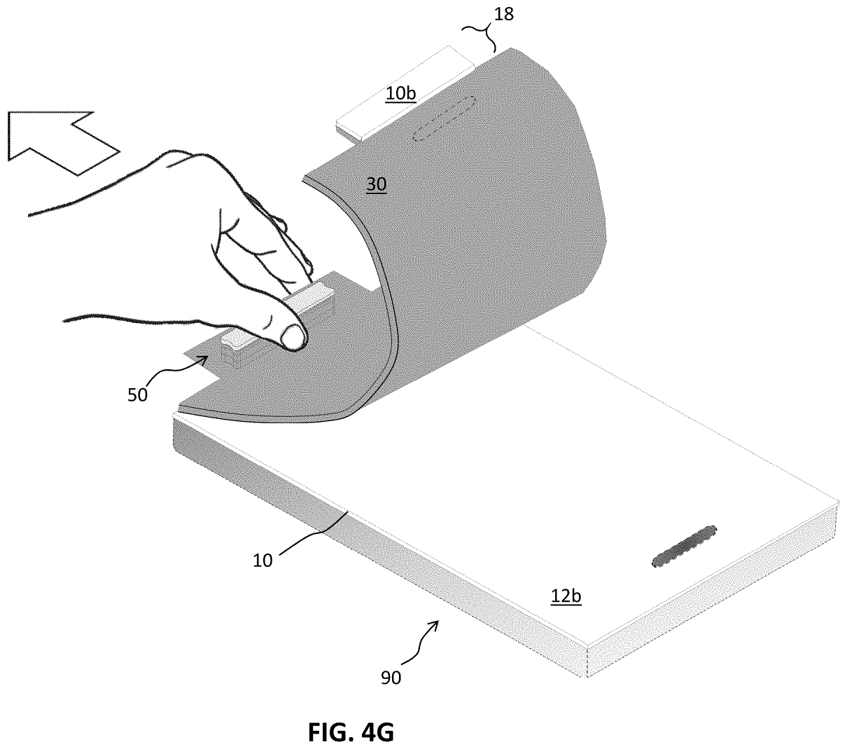

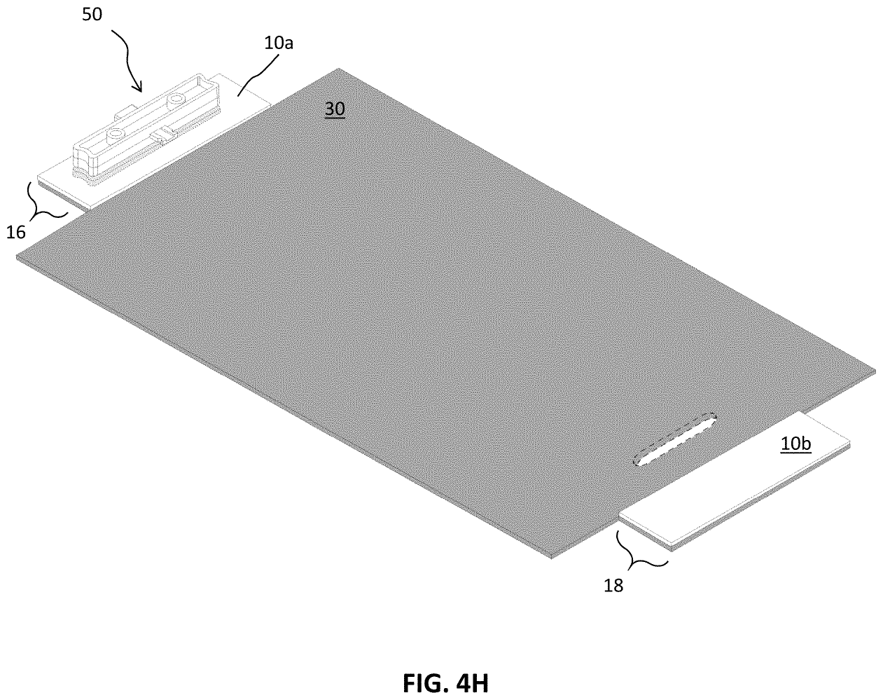

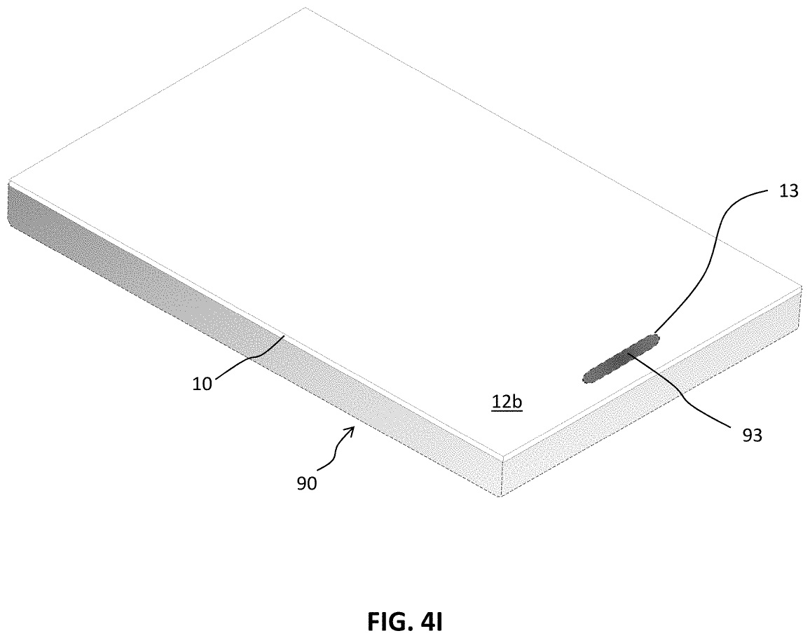

An exemplary method for installing the protective film 10 of FIGS. 1 and 2 on an example electronic device 90 will now be described with reference to FIGS. 4A-I. With reference first to FIG. 4A, the protective film product 100 is depicted being coupled to the applicator 50 of FIGS. 3A-D by initially inserting the protrusions 52 of the second clip portion 50a through the apertures 17 of the first tab 16. Because the example protective film product 100 comprises a protective film 10 having a first major surface portion 12a shaped and sized to adhere to the front screen of the particular device 90, the protective film product 100 and applicator are orientated relative to one another such that the protective film product 100 generally extends from the side of the applicator 50 from which the projection 58a matching the configuration of the port 98 (e.g., a microUSB port) extends. Additionally, the installer can confirm that the backing layer 20 is generally disposed between the projection 58a of the applicator 50 and the protective film 10 such that the adhesive area on the first major surface 12a can be applied to the surface of the electronic device. In cases such as this example in which the projection 58a is not symmetric, the installer can additionally confirm that protective film product 100 will be properly disposed when the projection 58a is inserted into the port 98. As shown in FIG. 4A, the first clip portion 50a is orientated as in FIG. 3B and the film product 100 has been flipped over to ensure that the backing layer 20 is disposed closest to projection 58a, while the cap layer 30 is disposed furthest away. Thereafter, the protrusions 52 can be inserted into the bores 57 of the first clip portion 50a and the first and second clip portions 50a,b squeezed together to join these portions of the applicator 50 via compression fit, with each one of the apertures 17 of the first tab 16 surrounding one of the protrusions 52.

As shown in FIG. 4B, the applicator 50 having the protective film 10 coupled thereto can then be coupled to the electronic device 90. In particular, the projection 58a can be inserted into the port 98 of the electronic device 90 until the applicator 50 is secured thereto. By way of example, the projection 58a of the applicator 50 may be configured to be partially or fully inserted within the port 50, for example, until the side surface of the applicator 50 abuts the side of the electronic device 90. With the applicator 50 now engaged with the port 98, it will be appreciated that the applicator 50 thus provides a fixed frame of reference for the protective film 10. In various aspects, the applicator 50 may therefore be coupled to the protective film product 100, for example, such that movement of the protective film 10 is restrained during installation.

With reference now to FIG. 4C, another exemplary step in the installation of the protective film 10 on the device 90 is schematically depicted. As shown in FIG. 4C, the installer may lift a portion of the protective film product 100 from the surface of the device 90 and the backing layer 20 may be removed. By way of example, an installer can begin to remove the backing layer 20 by separating a corner of the backing layer 20 of first major surface portion 12a, and then peeling the remainder of the backing layer to expose the adhesive area.

With reference now to FIG. 4D, the installer can begin to contact the exposed adhesive area of protective film 10 with the surface of the device 90. In particular, an installer may utilize the second tab 18 to generally pull the protective film 10 away from the applicator 50 to align the protective film 10 over the surface of the electronic device. By way of example, it will be appreciated that having the two protrusions 52 of applicator 50 extend through the apertures 17 of the first tab 16 can be effective to limit translational motion of the protective film 10 relative to the applicator 50 (e.g., along the plane of the front surface of device 90), thereby reducing the likelihood of misalignment. Additionally or alternatively, the two circular protrusions 52 may limit rotation of the protective film about an axis parallel to a central axis of the protrusions 52 (e.g., to limit rotation within the plane of the front surface of device 90), which may also reduce the likelihood of misalignment.

As shown in FIG. 4D, a mechanical smoothing device such as a squeegee may be used to apply pressure to the cap sheet 30, preferably from a location adjacent the applicator 50 in an effort to push any air bubbles out. While a mechanical smoothing device may also be applied to protective film products that lack a cap sheet (e.g., directly to the second major surface of the protective film), the cap sheet 30 may allow for the use of a wider and/or more rigid mechanical smoothing device during the installation process. For example, the mechanical smoothing device may have approximately the same width as the entire electronic device (e.g., eReader, computer notebook, tablet, etc.) or a portion of the electronic device (such as a display screen) to which the protective film 10 is to be applied. Additionally, the cap sheet may be sufficiently rigid to withstand the pressure applied by the mechanical smoothing device to minimize resulting damage (e.g., distortion) to the protective film 10. It will be appreciated that the smoothing device may be formed from a variety of materials, including a thick, heavy gauge paper (e.g., greater than about 50 mils thick, between about 50-150 mils thick, between about 50-90 mils thick, between about 50-80 mils thick, between about 60-80 mils thick, or about 70 mils thick), polyvinyl chloride acetate (PVCA), unplasticized polyvinyl chloride (uPVC), silicone rubber, ethylene propylene diene monomer (M-class) rubber (EPDM rubber), and/or other semi-rigid rubbers, and/or rigid plastics, such as rigid polyethylene (e.g., HDPE, MDPE, or LDPE), polyvinyl chloride (PVC), and/or polypropylene. For example, the smoothing device may be formed from silicone rubber and/or EPDM rubber that is about 60 to 90 Shore A durometer in hardness.

A wider mechanical smoothing device may provide several advantages. For example, a wider mechanical smoothing device may only need to be applied once (as it may be about the same width as the area to be adhered), thereby decreasing installation time. Additionally, a wider mechanical smoothing device may minimize unintended skewing, repositioning, and/or stretching of the protective adhesive film that may occur as a result of multiple squeegee applications (e.g., in different directions with respect to the screen of an eReader, etc.). A wider and harder mechanical smoothing device may also allow the user to apply increased downward force/pressure on the cap sheet 30, resulting in an increased adherence of the protective film 10 to the electronic device 90 and/or reduced air bubbles between the protective film 10 and the electronic device 90.

After the first major surface 12a has been applied to the surface of the electronic device 90 as shown in FIG. 4D, the installer may wish to confirm the alignment with the device and/or to ensure that all large bubbles have been removed. If misaligned or large bubbles are observed, the installer may choose to lift the protective film 10 from the surface of the device and repeat one or more steps of the installation process described above with reference to FIGS. 4A-D If, however, the film 10 appears bubble free and properly aligned with the surface portion of the device 90 desired to be covered, the installer may begin to remove the cap sheet 30 from the second major surface portion 12b of the protective film 10, for example, by grasping and twisting the second tab 18 as shown in FIG. 4E to separate the weakened area (e.g., perforations 15b) separating the tab portion 10b from the second edge 14b of the protective film 10. As the installer continues to pull the second tab 18 toward the applicator 50, cap sheet 30 is peeled from the second major surface portion 12b, as shown in FIG. 4F.

Upon fully removing (e.g., peeling) the cap sheet 30 from the second major surface 12b of the protective film 10, the installer can grasp the applicator 50 and pull away from the device 90 such that the projection 58 disengages from port 98 as shown in FIG. 4G. FIG. 4I depicts the surface of the device 90 having a properly aligned protective film on its surface, with opening 13 also properly aligned with the speaker 93. With reference again to FIG. 4H, the clip portions 50a,b of applicator 50 may be pulled apart to remove their coupling with the first tab 16. The remainder of the protective sheet product 100 (i.e., tab portion 10a, cap sheet 30, and tab portion 10b) can be discarded and the applicator 50 may be reserved for a future installation of a protective film having the same or different configuration as the protective film 10 to a front or back surface of a device of the same or different make or model as device 90. That is, with foreknowledge of the electronic device surface desired to be covered by a protective film, a particular protective film product can be produced to correspond to each of a plurality of particular devices and/or each surface of a particular device (e.g., the back and front of a device), with the applicator and protective film product working in concert to assist with the accurate and reproducible alignment and installation of the protective film to the desired surface.

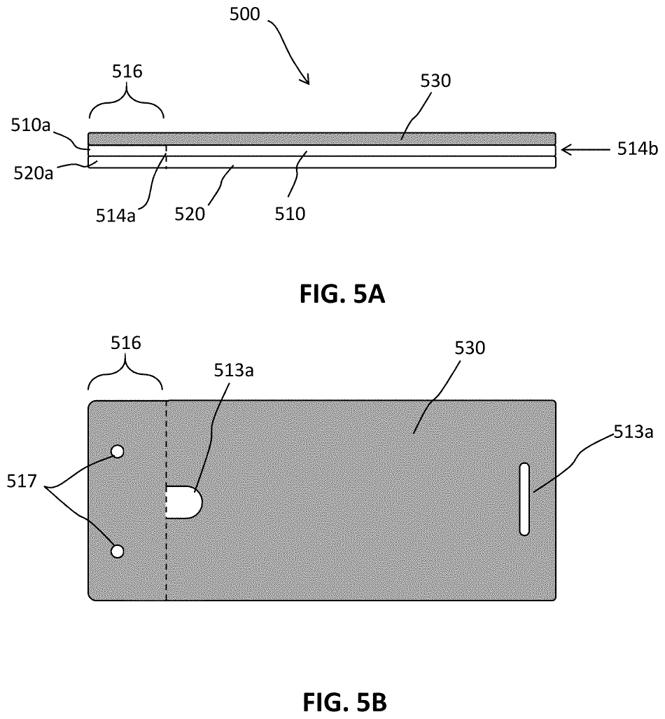

By way of example, another protective film product 500 for applying a protective film 510 to the front surface of a different electronic device from that of FIG. 4I is schematically depicted in FIGS. 5A-B. The protective film product 500 is substantially similar to that of FIG. 2, including the size, shape, and positioning of apertures 517. In this manner, the protective film product 500 can be coupled to the same applicator 50 of FIG. 3A-D, but applied to a device having a different configuration from that of device 90 of FIG. 4I. For example, the shape and/or size of the major surfaces of the protective film 510 may differ, and/or the protective film may comprise different openings to accommodate different features of the phone. As shown, two openings are provided in the protective film 510, a first opening 513a for a speaker and a second opening for a home button.

The protective film product 500 also differs from that depicted above in that a second tab is not provided opposite the first tab 516 (which extends beyond the edge 514a of the protective film 510). The first tab 516 of FIGS. 5A-B also differs from the first tab 16 of FIG. 2 in that the tab 516 extends the entire width of the protective film product 500, and additionally includes a tab portion 520b of the backing layer 520 (in addition to a portion of the cap layer 530 and tab portion 510b). Like the tab portion 510a (and tab portion 10a of FIG. 2), the tab portion 520b may be partially connected to the backing layer 520 (e.g., via one or more perforations or a kisscut) or may be separated therefrom via a throughcut near edge 514a such that removing the backing layer 520 (as in FIG. 4C) may be effective to separate the tab portion 510b. It will be appreciated that such a configuration may simplify production of the multi-layer protective film product 500 in that each layer may comprise the same size and shape such that an adhesive area can be uniformly added to the first major surface of the protective film 510. Moreover, a single cut of the multiple layers may result in the shape and size of the outline of the protective film product as shown in FIG. 5B, without having to differentially cut and/or remove the tab portion 520b prior to installation.

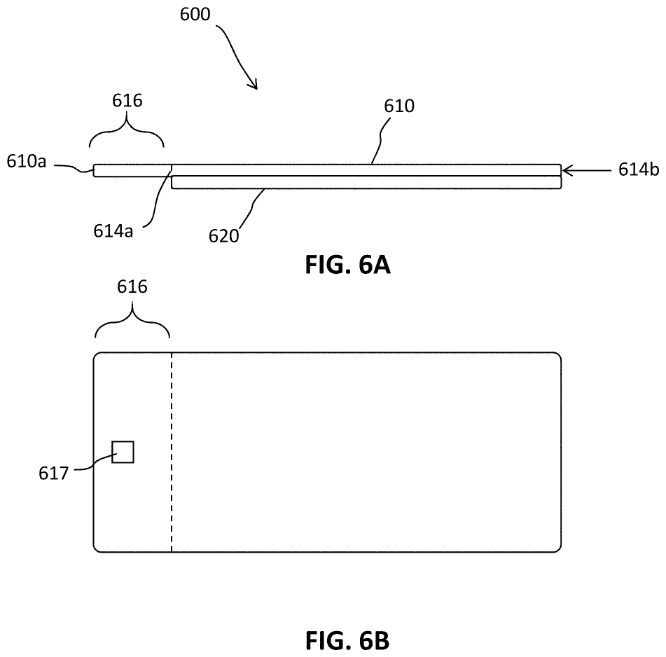

Another example protective film product 600 for applying a protective film 610 to the surface of an electronic device is schematically depicted in FIGS. 6A-B. The protective film product 600 is different from that of FIG. 2 in that a cap sheet is not provided. Rather the protective film product 600 comprises a protective film 610, a backing layer 620, and a tab 616 extending beyond the first edge 614a of the protective film 610. As shown in FIG. 6A-B, the tab 616 comprises a tab portion 610b of the same material integrally connected via one or more perforations, for example, at the first edge 614a of the protective film 610. Upon attaching the protective film 610 to the surface of the electronic device, the corresponding applicator may be removed, with the movement causing separation of the tab portion 610a from the protective film 610 at the weakened area.

The protective film product 600 also differs from those discussed above in that the tab 616 comprises only a single aperture 617 of a non-circular shape (i.e., square). It will be appreciated that while a single circular aperture may limit translational motion relative to an applicator having a circular protrusion extending through the circular aperture, such an aperture may not be effective to limit rotation of the protective film about an axis defined by the circular protrusion. Accordingly, the present teachings provide that one or more apertures (e.g., aperture 617) through the first tab 616 may preferably comprise a non-circular shape such as an ellipse or polygon (e.g., square) that limits rotational movement of the protective film 610, especially when only a single aperture is provided. In related aspects, a corresponding applicator (not shown) may likewise provide one or more corresponding non-circular protrusion(s) exhibiting a size and cross-sectional shape conforming to the size and shape of the aperture 617 as otherwise discussed herein.

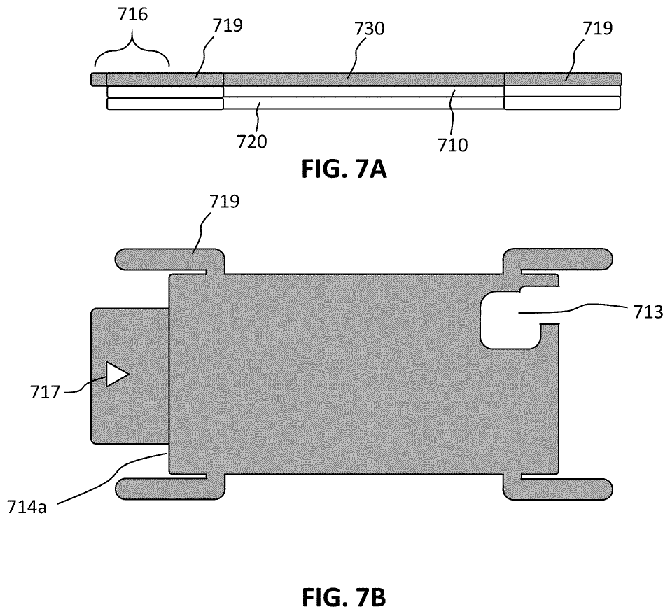

Another example protective film product 700 having a protective film 710 to be applied to the surface of an electronic device is schematically depicted in FIGS. 7A-B. The protective film product 700 is similar to those examples discussed above, but differs in that the first tab 716 extending beyond the first edge 714a of the major surface portions of the protective film 710 only contains a single layer (i.e., cap sheet 730). That is, in accordance with various aspects of the present teachings, the tab 716 is coupled to the protective film 710 indirectly (e.g., through the cap sheet 730). The protective film product 700 also differs in that the opening 713 is a cutout that is not fully surrounded by the protective film, but instead extends from an edge of the protective film to leave a camera uncovered, for example, while covering the remainder of the surface portion of the device desired to be covered. As shown in FIGS. 7A-B, the shape and size of the major surfaces of the protective film 710 additionally include four wings 719 that are configured to bend around the sides of the electronic device and to be applied over the corners for improved impact resistance at these locations.

The section headings used herein are for organizational purposes only and are not to be construed as limiting. While the applicant's teachings are described in conjunction with various embodiments, it is not intended that the applicant's teachings be limited to such embodiments. On the contrary, the applicant's teachings encompass various alternatives, modifications, and equivalents, as will be appreciated by those of skill in the art.

What is claimed is:

1. An applicator for applying a protective film to a portable electronic device, the applicator comprising:
a first clip portion having an upper and lower surface, the lower surface comprising at least one bore;
a second clip portion having an upper and lower surface, the upper surface comprising at least one protrusion configured to be received within the at least one bore of the first clip portion; and
a first projection extending from a first side surface of one of the first and second clip portions, the first projection configured to engage a port of a first portable electronic device to enable alignment of a first protective film product on a first surface portion of the first portable electronic device, the first protective film product comprising:
a protective film having a first major surface extending between a first edge and a second edge and a second major surface opposite the first major surface, wherein the first and second major surfaces are sized and shaped to correspond to the first surface portion of the first portable electronic device;
an adhesive layer disposed on the first major surface of the protective film, the adhesive layer comprising an adhesive that provides tack sufficient to securely adhere the protective film to the first surface portion of the first portable electronic device; and
a first tab removably coupled to the protective film and extending beyond the first edge of the first major surface, the first tab having at least one aperture extending therethrough for receiving the at least one protrusion of the second clip portion when retained within the bore of the first clip portion such that the first tab is disposed between the clip portions during application of the protective film to the first surface portion of the first portable electronic device.

2. The applicator of claim 1, wherein the at least one protrusion is configured to engage the at least one aperture of the first tab so as to limit translational motion of the protective film relative to the first and second clips.

3. The applicator of claim 1, wherein the at least one protrusion is configured to engage the at least one aperture of the first tab so as to limit rotational movement of the protective film about an axis parallel to a central axis of the at least one protrusion.

4. The applicator of claim 1, wherein a cross sectional shape of the at least one protrusion is the same as a cross sectional shape of the at least one aperture.

5. The applicator of claim 4, wherein the cross sectional shape is one of a circle, an ellipse, and a polygon.

6. The applicator of claim 1, wherein the second clip portion comprises a plurality of protrusions and the first clip portion comprises a plurality of bores and wherein the first tab comprises a plurality of apertures such that each of the plurality of protrusions is configured to simultaneously extend through one of the plurality of apertures to engage one of the plurality of bores.

7. The applicator of claim 1, wherein the at least one protrusion is configured to be retained within the at least one bore via compression fit.

8. The applicator of claim 1, wherein the first and second clip portions are configured to be coupled via press fit.

9. The applicator of claim 1, wherein the first projection is configured to enable alignment of a second protective film product to a second surface portion of the first electronic device, wherein the first and second surface portions are disposed on opposite sides of the first electronic device, the second protective film product comprising:
a protective film having a first major surface extending between a first edge and a second edge and a second major surface opposite the first major surface, wherein the first and second major surfaces are sized and shaped to correspond to the second surface portion of the first portable electronic device;
an adhesive layer disposed on the first major surface of the protective film, the adhesive layer comprising an adhesive that provides tack sufficient to securely adhere the protective film to the second surface portion of the first portable electronic device; and
a first tab removably coupled to the protective film and extending beyond the first edge of the first major surface, the first tab having at least one aperture extending therethrough for receiving the at least one protrusion of the second clip portion when retained within the bore of the first clip portion such that the first tab is disposed between the clip portions during application of the protective film to the second surface portion of the first portable electronic device.

10. The applicator of claim 1, further comprising a second projection extending from a second side surface opposed to the first side surface, wherein the second projection is configured to engage a port of a second portable electronic device to enable alignment of a second protective film product to a first surface portion of the second portable electronic device, wherein the second portable electronic device is different from the first portable electronic device.

11. The applicator of claim 10, wherein the second protective film product comprises:
a protective film having a first major surface extending between a first edge and a second edge and a second major surface opposite the first major surface, wherein the first and second major surfaces are sized and shaped to correspond to the first surface portion of the second portable electronic device;
an adhesive layer disposed on the first major surface of the protective film, the adhesive layer comprising an adhesive that provides tack sufficient to securely adhere the protective film to the first surface portion of the second portable electronic device; and
a first tab removably coupled to the protective film and extending beyond the first edge of the first major surface, the first tab having at least one aperture extending therethrough for receiving the at least one protrusion of the second clip portion when retained within the bore of the first clip portion such that the first tab is disposed between the clip portions during application of the protective film to the first surface portion of the second portable electronic device,
wherein at least one of the size and shape of the first surface portions of the first and second electronic devices are different.

12. A protective film product for a portable electronic device, comprising:
a protective film having a first major surface extending between a first edge and a second edge and a second major surface opposite the first major surface, wherein the first and second major surfaces are sized and shaped to correspond to a surface portion of the portable electronic device;
an adhesive layer disposed on the first major surface of the protective film, the adhesive layer comprising an adhesive that provides tack sufficient to securely adhere the protective film to the surface portion of the portable electronic device; and
a first tab removably coupled to the protective film and extending beyond the first edge of the first major surface, the first tab having at least one aperture extending therethrough for receiving a protrusion of an applicator during application of the protective film to the surface portion of the portable electronic device.

13. The protective film product of claim 12, wherein the first tab is configured to engage the applicator so as to align the protective film with the surface portion of the portable electronic device during application.

14. The protective film product of claim 13, wherein the first tab is configured to engage the applicator so as to limit translational motion of the protective film relative to the applicator.

15. The protective film product of claim 13, wherein the first tab is configured to engage the applicator so as to limit rotational movement of the protective film about an axis parallel to a central axis of the protrusion.

16. The protective film product of claim 12, further comprising a removable cap sheet disposed on the second major surface of the protective film.

17. The protective film product of claim 16, wherein at least a portion of the tab is integrally formed with the cap sheet.

18. The protective film product of claim 17, wherein the tab comprises the cap sheet and a tab portion of the same material as the protective film.

19. The protective film product of claim 18, wherein the tab portion is configured to separate from the first edge of the protective film when the cap sheet is removed.

20. The protective film product of claim 19, wherein the tab portion is integrally connected with the first edge of the protective film via a set of perforations.

21. The protective film product of claim 19, wherein the tab portion is separated from the first edge of the protective film via a kisscut.

22. The protective film product of claim 16, wherein micro air pockets are formed in gaps between a textured surface of said cap sheet and said second major surface of said protective film.

23. The protective film product of claim 12, wherein the tab is integrally formed with the protective film.

24. The protective film product of claim 23, wherein the tab is connected to the first edge of the protective film via a set of perforations.

25. The protective film product of claim 12, wherein a cross sectional shape of the at least one aperture is the same as a cross sectional shape of the protrusion.

26. The protective film product of claim 25, wherein the cross sectional shape is one of a circle, an ellipse, and a polygon.

27. The protective film product of claim 12, wherein the first tab comprises a plurality of apertures and the applicator comprises a plurality of protrusions, wherein each of the plurality of apertures is configured to simultaneously receive therethrough one of the plurality of protrusions.

28. The protective film product of claim 12, further comprising a second tab removably coupled to the protective film and extending beyond the second edge of the first major surface.

29. A method of applying a protective film to a portable electronic device, the method comprising:
providing a protective film product comprising:
a protective film having a first major surface extending between a first edge and a second edge and a second major surface opposite the first major surface, wherein the first and second major surfaces are sized and shaped to correspond to a surface portion of the portable electronic device;
an adhesive layer disposed on the first major surface of the protective film, the adhesive layer comprising an adhesive that provides tack sufficient to securely adhere the protective film to the surface portion of the portable electronic device; and
a first tab removably coupled to the protective film and extending beyond the first edge of the first major surface, the first tab having at least one aperture extending therethrough;
providing an applicator comprising:
a first clip portion having an upper and lower surface, the lower surface comprising at least one bore;
a second clip portion having an upper and lower surface, the upper surface comprising at least one protrusion; and
a first projection extending from a first side surface of one of the first and second clip portion;
inserting the at least one protrusion through the at least one aperture of the tab of the protective film product;
coupling the first clip portion to the second clip portion by inserting the at least one protrusion of the first clip portion into the at least one bore of the second clip portion;
inserting the projection of the applicator into a port of the portable electronic device to align the protective film with the surface portion of the portable electronic device;
applying pressure to the second major surface of the protective film product to press the adhesive layer against the surface portion of the portable electronic device; and
removing the tab from the protective film.
